(19) United States
(12) Patent Application Publication
(10) Pub. No.: US 2006/0085228 A1
(43) Pub. Date: Apr. 20, 2006

(54) System of conserving health-care buyers' resources

(76) Inventors: Anuthep Benja-Athon, NY, NY (US); Nontawan Benja-Athon, Port Washington, NY (US)

Correspondence Address: ANUTHEP BENJA-ATHON, 210 E 36th St., NY, NY, 10016, US

(21) Appl. No.: 11/293,689

(22) Filed: Dec. 5, 2005

Related U.S. Application Data
(63) Continuation-in-part of application No. 11/114,763, filed on Apr. 27, 2005.
Application No. 11/114,763 is a continuation-in-part of application No. 10/328,993, filed on Dec. 26, 2002.

(51) Int. Cl. G06Q 10/00

(52) U.S. Cl. 705/2

(57) ABSTRACT

A system of conserving health-care resources of health-care buyers and health-care consumers comprises the displays and uses of health-care consumers' health and health-care data based on which physicians and patients interact using a network of computers and servers to effect the allocations, uses and conservations of health-care resources of health-care buyers and health-care consumers.

This application is a continuation-in-part of 10/328,993 entitled the Best American Healthcare System filed Dec. 26, 2002 and a continuation-in-part of 11/114,763 entitled A System of Influencing Health-Care Utilizations filed Apr. 27, 2005 which are pending.

### FIELD OF INVENTION

Health-care buyers' and consumers' management of their health-care resources.

### BACKGROUND OF THE INVENTION

Recently, Congress enacted the Health Reimbursement Arrangements (HRA), the Health Savings Account (HSA) and the like as an attempt to control heath-care costs of health-care buyers and consumers and provide some means of health-care coverage for more than 40 million uninsured Americans in the current American health-care system. However, unfortunately, no one including said health-care buyers and consumers heretofore have the system, means and know-how to achieve the aim of said enactments.

Specifically, the present invention best applies to HRA and its derivatives and the like because, in the spirit of the present invention and within the scope of the claims infra, the health-care resources such as, but not limited to, money, portions of the revenues, earnings and incomes of patients, employers, companies or corporations assign or allocate to cover and pay for health-care expenses and related of themselves, said employers', companies' or corporations' employees and their families belong or own—by law—by said patients, employers, companies or corporations.

For the first time in the history of humankind, the present invention provides the unique system or method allowing hundreds of millions of health-care buyers and consumers to actively and directly modulate and control their health-care resources to get the best returns or benefits for themselves so that the standards of living of almost all Americans will be significantly improved.

The present invention provides a system or method for effecting the optimal uses and allocations of the health-care resources of health-care buyers and health-care consumers to optimally benefit said buyers and consumers.

### SUMMARY OF THE INVENTION

Recently, Congress enacted the Health Reimbursement Arrangements (HRA), the Health Savings Account (HSA) and the like as an attempt to allow health-care buyers and consumers to take charge of their health-care resources. Unfortunately, no one including said health-care buyers and consumers heretofore have the system, means and know-how to achieve the aim of said enactments.

The present invention is system or method of conserving health-care resources of health-care buyers and health-care consumers comprises the displays and uses of health-care consumers' health and health-care data based on which physicians and patients interact using a network of computers and servers to effect the allocations, uses and conservations of health-care resources of said health-care buyers and health-care consumers.

### DESCRIPTION OF PREFERRED EMBODIMENTS

The present invention provides a system or method wherein the interactions between health-care consumers such as, but not limited to, patients, heath-care buyers and physicians via and within a network of computers and servers effect the optimal uses and managements of health-care resources of health-care buyers and health-care consumers by health-care consumers and health-care buyers leading to conservations or preservations of said health-care resources for benefitting said consumers and buyers.

The present invention uses health and health-care data on or relating to health-care consumers henceforth known as patients generated by physicians and inputted into electronic devices including computers network to a network of computers or servers—taught in the earlier and pending patent applications of this physician applicant and his co-applicants—to allow the achievement of the objectives of the present invention. Furthermore, the present invention uniquely provides a system or method of further generating more health and/or health-care data on or relating to said health and health-care data by and/or among patient or patients and physicians via and within a network of computers or servers to achieve the objectives of the present invention.

The present invention provides a system or method for any and all patients to view, acknowledge, comment and feedback (or, in certain settings and circumstances, not to input, comment or feedback) on said health and health-care data on or relating to patients generated by his or her physician and/or physicians.

In other words, the present invention provides a process of displaying a patient's health and health-care data according to the teaching supra viewable as a display or multiple displays on a display screen of a computer or display screens of computers at locations such as, but not limited to, home, homes, office or offices. Similarly, individual patients are permitted to appropriately view—according to the law—individual health and health-care data generated by individual physicians. In most circumstances, said parties are situated in different locations and premises.

Further to supra, each and every patient can address, input, comment and/or feedback on his or her said health and health-care data and the related generated by physician or physicians. Similarly, individual patients are permitted to appropriately view—according to the law—and address, input, comment and/or feedback on their said health and health-care data. In the computers being used by patients, the present invention provides patients with a means for accepting and a mean for recording said patients' inputs, comments, feedbacks and the like on appropriate health and health-care data generated by their physicians as govern by the privacy law. In other words, each and every patient may and can enter his or her input/inputs, comment/comments, feedback/feedbacks and the like pertaining or relating to health and health-care information generated by his or her physician and/or physicians at any time. Said means for accepting comprises individual spaces or areas appropriately associate with or relate to said health and health-care data present to each and every patient on a computer screen. Similarly, individual patients using computer display screens are permitted to—according to the law—achieve same.

Furthermore, said means for recording comprises entry or entries of each patient's input/inputs, comment/comments, feedback/feedbacks and the like into said spaces or areas on said display screen. In other words, into each space or area on a computer display screen, each and every patient may and can enter his or her said input/inputs, comment/comments, feedback/feedbacks and the like after he or she reviewed relating said health and health-care data on him or her. All methods and means for recording which are readily provided by the present and future computer technologies and software can be used such as, but not limited to, first, each and every patient can record or enter individual input/inputs, comment/comments, feedback/feedbacks and the like into said spaces or areas. Second, a customized pre-entered list or menu of inputs, comments and feedbacks such as, but not limited, to “None”, “No Chief Complaint”, “No Diagnosis”, “No Visit”, “No Treatment Performed”, “No Procedure Performed”, “No Surgery Performed”, etc., etc. are presented to each patient from which he or she can select one or a few statements in total and submit said statement or selection at a time or a click at a time or, better yet, submit at one time or a click all statements or selections for data storage and for further processing infra.

Consequently, each and every patient's said inputs, comments and/or feedbacks and related are transmitted to appropriate physician and/or physicians who are involved with said patient and also who are a part of this system for achieving the objectives of the present invention.

In other words, each and every patient may and can enter his or her input/inputs, comment/comments, feedback/feedbacks and the like pertaining or relating to health and health-care information generated by his or her physician or physicians at any time. The present invention further provides a means for displaying a patient's and patients' inputs including comments and feedbacks and a means for recording a patient's and patients' inputs including comments and feedbacks. Said means for displaying comprises individual spaces or areas on the computer display screens being used by physicians and appropriately associate with or relate to said health and health-care data present supra to each patient. The process of displaying a health-care consumer's or consumers' inputs including comments or feedbacks to a physician or physicians comprises displaying said inputs including comments and feedbacks in said individual spaces or areas on the computer display screens being used by physicians and appropriately associate with or relate to said health and health-care data present supra to each patient.

Said means for recording a patient's and patients' inputs including comments and feedbacks comprises computer data storage wherein selective and appropriate said data and information are adaptable to be stored and retrieved for searches and recalls for appropriate sorting and viewing by authorized persons.

The process of acting on a health-care consumer's or health-care consumers' said inputs including comments and feedbacks by a physician or physicians comprises a physician or physicians may and can enter the responses comprise input/inputs, comment/comments, feedback/feedbacks and the like pertaining or relating to said health-care consumer's or health-care consumers' said inputs. In other words, physician and/or physicians can and may enter his, her or their input/inputs, comment/comments, feedback/feedbacks and the like on or to said health-care consumer's or health-care consumers' said inputs, comments and feedbacks after he, she or they reviewed said health and health-care data and information, inputs, comments and feedbacks. All methods and means for acting or responding are readily provided by the present and future computer technologies and software can be used such as, but not limited to, first, said physician or physicians can and may record or enter individual input/inputs, comment/comments, feedback/feedbacks and the like into said spaces or areas. Second, a customized pre-entered list or menu of physician's or physicians' inputs, comments and feedbacks are presented to each and every physician from which he, she or they can select one or a few statements in total and submit said statement or selection at a time or a click at a time or, better yet, submit at one time or a click all statements or selections for data storage and for further processing infra.

A means for storing the outcomes of said process of acting on a health-care consumer's and consumers' inputs including comments and feedbacks comprises computer data storage wherein selective and appropriate said data and information are adaptable to be searched and recalled for appropriate sorting and viewing by authorized persons.

It is understood that the above preferred embodiments apply to tens or hundreds of millions of patients and health-care buyers and physicians who participate in the care of or the delivery of care to said patients and those physicians and assistants who participate in this system or use the methods and processes of the present invention and said pending patent applications.

Said physicians comprise treating physicians and/or peer-reviewed physician and physicians and those who are qualified to serve same functions as said physicians and are authorized to assess said data and information being presented to them.

It is understood that by law, a health-care consumer or patient can and will only see his or her health and health-care data although authorized physicians can and will see any and all health and health-care data of any and all patients.

It is understood that health-care consumers are patients although employers, companies, corporations and governments may also be defined as health-care consumers, and health-care buyers are such as, but not limited, to employers, companies, corporations, governments and certain patients. The commonly well-known certain patients are the tens of millions of uninsured Americans.

The terms health-care, health care and healthcare have the same meaning and application herein. Health-care resources used herein are such as, but not limited to, dollars or money that are owned or controlled by health-care buyers and consumers.

Although the preferred embodiments of the present invention best applies to the Health Reimbursement Arrangements (HRA), the Health Savings Account and the like and their derivatives, it will be appreciated by those skilled in business, sciences and medicine that variations, additions and adaptations can be made to the present invention so that the embodiments can and will apply to similar and future health or health-care products without departing from the spirit of the invention and the scope of the claims.

Although the preferred embodiments have been described, it will be appreciated by those skilled in business, sciences and medicine that variations, additions and adaptations to the present invention can be made without departing from the spirit of the invention and the scope of the claims.

1. A system of conserving health-care resources of health-care buyers and health-care consumers comprises:
a display of a health-care consumer's health data;
a display of a health-care consumer's health-care data;
displays of health-care consumers' health data;
displays of health-care consumers' health-care data;
a process of displaying a health-care consumer's health data;
a process of displaying health-care consumer's health-care data;
a process of displaying health-care consumers' health data;
a process of displaying health-care consumers' health-care data;
a process of displaying a health-care consumer's health data to said health-care consumer;
a process of displaying a health-care consumer's health-care data to said health-care consumer;
a process of displaying health data to health-care consumers;
a process of displaying health-care data to health-care consumers;
a means for accepting a health-care consumer's inputs including comments and feedbacks;
a means for accepting health-care consumers' inputs including comments and feedbacks;
a means for recording a health-care consumer's inputs including comments and feedbacks;
a means for recording health-care consumers' inputs including comments and feedbacks;
a process of commenting on health data by a health-care consumer;
a process of commenting on health-care data by a health-care consumer;
a process of commenting on health data by health-care consumers;
a process of commenting on health-care data by health-care consumers;
a process of transmitting a health-care consumer's inputs including comments and feedbacks to a physician;
a process of transmitting a health-care consumer's inputs including comments and feedbacks to physicians;
a process of transmitting health-care consumers' inputs including comments and feedbacks to physicians;
a means for displaying a health-care consumer's inputs including comments and feedbacks;
a means for displaying a health-care consumer's inputs including comments and feedbacks;
a means for displaying health-care consumers' inputs including comments and feedbacks;
a means for recording a health-care consumer's inputs including comments and feedbacks;
a means for recording health-care consumers' inputs including comments and feedbacks;
a process of displaying a health-care consumer's inputs including comments and feedbacks to a physician;
a process of displaying a health-care consumer's inputs including comments and feedbacks to physicians;
a process of displaying health-care consumers' consumer's inputs including comments and feedbacks to physicians;
a means for acting on a health-care consumer's inputs including comments and feedbacks;
a means for acting on health-care consumers' inputs including comments and feedbacks;
a process of acting on a health-care consumer's inputs including comments and feedbacks;
a process of acting on health-care consumers' inputs including comments and feedbacks.
a means for storing the outcomes of said process of acting on a health-care consumer's inputs including comments and feedbacks; and
a means for storing the outcomes of said process of acting on health-care consumers' inputs including comments and feedbacks.

2. A system of utilizations of health and health-care information on health-care consumers generated by physicians and inputted into electronic devices link to a network of computers or servers for effecting the allocations, uses or conservations of health-care resources of health-care buyers and health-care consumers comprises:
a display of a health-care consumer's health data;
a display of a health-care consumer's health-care data;
displays of health-care consumers' health data;
displays of health-care consumers' health-care data;
a process of displaying a health-care consumer's health data;
a process of displaying health-care consumer's health-care data;
a process of displaying health-care consumers' health data;
a process of displaying health-care consumers' health-care data;
a process of displaying a health-care consumer's health data to said health-care consumer;
a process of displaying a health-care consumer's health-care data to said health-care consumer;
a process of displaying health data to health-care consumers;
a process of displaying health-care data to health-care consumers;
a means for accepting a health-care consumer's inputs including comments and feedbacks;
a means for accepting health-care consumers' inputs including comments and feedbacks;
a means for recording a health-care consumer's inputs including comments and feedbacks;
a means for recording health-care consumers' inputs including comments and feedbacks;
a process of commenting on health data by a health-care consumer;
a process of commenting on health-care data by a health-care consumer;
a process of commenting on health data by health-care consumers;
a process of commenting on health-care data by health-care consumers;
a process of transmitting a health-care consumer's inputs including comments and feedbacks to a physician;
a process of transmitting a health-care consumer's inputs including comments and feedbacks to physicians;
a process of transmitting health-care consumers' inputs including comments and feedbacks to physicians;
a means for displaying a health-care consumer's inputs including comments and feedbacks;
a means for displaying a health-care consumer's inputs including comments and feedbacks;
a means for displaying health-care consumers' inputs including comments and feedbacks;
a means for recording a health-care consumer's inputs including comments and feedbacks;
a means for recording health-care consumers' inputs including comments and feedbacks;
a process of displaying a health-care consumer's inputs including comments and feedbacks to a physician;
a process of displaying a health-care consumer's inputs including comments and feedbacks to physicians;
a process of displaying health-care consumers' consumer's inputs including comments and feedbacks to physicians;
a means for acting on a health-care consumer's inputs including comments and feedbacks;
a means for acting on health-care consumers' inputs including comments and feedbacks;
a process of acting on a health-care consumer's inputs including comments and feedbacks;
a process of acting on health-care consumers' inputs including comments and feedbacks.
a means for storing the outcomes of said process of acting on a health-care consumer's inputs including comments and feedbacks; and
a means for storing the outcomes of said process of acting on health-care consumer' inputs including comments and feedbacks.

3. A system of allocating health-care resources of health-care buyers and health-care consumers wherein health and health-care data on or relating to health-care consumers generated by physicians and inputted into electronic devices including computers network to a network of computers or servers are viewed and commented or not commented by health-care consumers using computers and wherein said health and health-care data and said health-care consumers' inputs including comments or feedbacks in said computers or servers are viewed and acted upon for effecting the uses or managements of said health-care resources comprises:
a display of a health-care consumer's health data;
a display of a health-care consumer's health-care data;
displays of health-care consumers' health data;
displays of health-care consumers' health-care data;
a process of displaying a health-care consumer's health data;
a process of displaying health-care consumer's health-care data;
a process of displaying health-care consumers' health data;
a process of displaying health-care consumers' health-care data;
a process of displaying a health-care consumer's health data to said health-care consumer;
a process of displaying a health-care consumer's health-care data to said health-care consumer;
a process of displaying health data to health-care consumers;
a process of displaying health-care data to health-care consumers;
a means for accepting a health-care consumer's inputs including comments and feedbacks;
a means for accepting health-care consumers' inputs including comments and feedbacks;
a means for recording a health-care consumer's inputs including comments and feedbacks;
a means for recording health-care consumers' inputs including comments and feedbacks;
a process of commenting on health data by a health-care consumer;
a process of commenting on health-care data by a health-care consumer;
a process of commenting on health data by health-care consumers;
a process of commenting on health-care data by health-care consumers;
a process of transmitting a health-care consumer's inputs including comments and feedbacks to a physician;
a process of transmitting a health-care consumer's inputs including comments and feedbacks to physicians;
a process of transmitting health-care consumers' inputs including comments and feedbacks to physicians;
a means for displaying a health-care consumer's inputs including comments and feedbacks;
a means for displaying a health-care consumer's inputs including comments and feedbacks;
a means for displaying health-care consumers' inputs including comments and feedbacks;
a means for recording a health-care consumer's inputs including comments and feedbacks;
a means for recording health-care consumers' inputs including comments and feedbacks;
a process of displaying a health-care consumer's inputs including comments and feedbacks to a physician;
a process of displaying a health-care consumer's inputs including comments and feedbacks to physicians;
a process of displaying health-care consumers' consumer's inputs including comments and feedbacks to physicians;
a means for acting on a health-care consumer's inputs including comments and feedbacks;
a means for acting on health-care consumers' inputs including comments and feedbacks;
a process of acting on a health-care consumer's inputs including comments and feedbacks;
a process of acting on health-care consumers' inputs including comments and feedbacks.
a means for storing the outcomes of said process of acting on a health-care consumer's inputs including comments and feedbacks; and
a means for storing the outcomes of said process of acting on health-care consumers' inputs including comments and feedbacks.
